(19) United States
(12) Patent Application Publication
(10) Pub. No.: US 2012/0238427 A1
(43) Pub. Date: Sep. 20, 2012

(54) PAPER ROLL WITH PRE-CUT WINDOWS

(76) Inventor: Ira Kristel, Manhasset, NY (US)

(21) Appl. No.: 13/304,144

(22) Filed: Nov. 23, 2011

Related U.S. Application Data
(63) Continuation-in-part of application No. 11/590,086, filed on Oct. 31, 2006, now Pat. No. 8,097,312.

(51) Int. Cl. B31B 1/14

(52) U.S. Cl. 493/227

(57) ABSTRACT

A method for manufacturing a paper product having a transparent window having the steps of: flattening two rectangular strips in the paper, cutting out a substantially rectangular window between the two rectangular strips, the window extending into the two rectangular strips. A substantially rectangular transparent material is placed over the window; the material has a greater length and a greater width than the window.

### CROSS-REFERENCE TO RELATED APPLICATIONS

The present application is a continuation-in-part of pending U.S. patent application Ser. No. 11/590,086 filed on Oct. 31, 2006, the content of which is incorporated herein by reference.

### FIELD OF THE INVENTION

The present invention relates to a paper product, and method of manufacturing a paper product, having a flattened area such that any transparent material placed on the flattened area has substantially the same thickness as the rest of the paper product.

### BACKGROUND OF THE INVENTION

High speed envelope manufacturing machines must meet the demands to produce large quantities of high quality envelopes in an inexpensive manner. These envelope machines have the capability of producing envelopes at speeds well in excess of 1,000 envelopes per minute and are typically microprocessor controlled high speed web machines which are designed to perform every aspect of envelope manufacturing, beginning with the unwinding of a continuous web of fibrous material. The roll of material is then fed through the envelope machine where it may be printed with desired information, provided with an adhesive material, cut to create a window area, provided with a transparent window for the window area, cut to form individual envelope units, and folded over a desired package as to create a stuffed envelope.

A shortcoming of the aforementioned envelope manufacturing machines is that they must operate at a slower rate when producing envelopes with windows. That is, the speed is limited by the speed at which a window area can be created in the roll of material and by the rate at which a transparent window can be placed overtop the window area. A manufacturer will therefore have to choose between producing envelopes at a slower rate and producing envelopes that do not contain a window. However, the envelope windows are beneficial in that they allow for the display of information about the contents of the envelope or about the individual to whom the envelope will be sent, such as the recipient's address.

To increase the rate of the envelope manufacturing process, the roll of material may include pre-cut openings and transparent windows. However, the roll of material consists of thousands of envelope units and will therefore contain thousands of transparent windows. These transparent windows, including the layer of transparent material, typically have a thickness on the order of 0.00575 inches, which adds to the total thickness of the base windowed envelope roll stock material.

A roll of envelopes with transparent windows will therefore have a non-uniform thickness. When this roll is wound up, it will have an asymmetrical diameter caused by the increase thickness of the added transparent layer around the envelope window. Given the size and weight of the roll and the speed at which the roll is unwound during the envelope making process, any significant asymmetry in the roll will cause the unwinding process, and the manufacturing process as a whole, to be uneven and erratic. In turn, this can cause shuddering or shaking in the envelope machine, which can result in damage to the machine or the roll of material.

What is desired, therefore, is an envelope manufacturing process that limits the asymmetry in the roll by limiting the area that has a raised thickness caused by the inclusion of a transparent layer over the window.

### SUMMARY OF THE INVENTION

The invention is directed to an envelope, and method of manufacturing thereof, that limits the thickness caused by the inclusion of a transparent material layer over the window. The method crushes certain areas of the envelope such that the added transparent layer does not significantly increase the thickness over the non-crushed area.

These and other objects of the present invention are achieved by provision of a method for manufacturing a paper product having a transparent window having the steps of: flattening two rectangular strips in the paper and cutting out a substantially rectangular window between the two rectangular strips, the window extending into the two rectangular strips. A substantially rectangular transparent material is placed over the window; the material has a greater length and a greater width than the window.

In some embodiments of the present invention, a combined thickness of one of the flattened rectangular strips and the transparent material is approximately equal to a thickness of a non-flattened area of the paper product. In some embodiments of the present invention, a portion of the paper product that is covered by the transparent material is not flattened. In some embodiments of the present invention, the paper product is an envelope. In some embodiments of the present invention, a roller flattens the two rectangular strips. In some embodiments of the present invention, the paper product is a roll of paper and a plurality of rectangular strips are flattened, a plurality of windows is cut, and transparent material is placed over each window. In some embodiments of the present invention, individual paper products are cut from the roll of paper product, each paper product having two rectangular strips, one window, and a transparent material covering the window.

In another embodiment of the present invention is a method for manufacturing a paper product having a transparent window comprising the steps of: flattening two portions of the paper, cutting out a window between the two portions, and placing a transparent material over the window, the transparent material having a greater area than an area of the window.

In some embodiments of the present invention, the two flatten portions are substantially rectangular. In some embodiments of the present invention, the window is substantially rectangular. In some embodiments of the present invention, a portion of the paper product that is covered by the transparent material is not flattened. In some embodiments of the present invention, a combined thickness of one of the flattened portions and the transparent material is approximately equal to a thickness of a non-flattened area of the paper product. In some embodiments of the present invention, the paper product is an envelope. In some embodiments of the present invention, the paper product is a roll of paper and a plurality of flattened portions are flattened on the roll, a plurality of windows is cut, and transparent material is placed over each window. In some embodiments of the present invention, individual paper products are cut from the roll of paper product, each paper product having two flattened portions, one window, and a transparent material covering the window.

In another embodiment of the present invention is method for manufacturing a roll of paper product having a plurality of transparent windows comprising the steps of: flattening a plurality of dual rectangular strips in the roll, cutting out a plurality of substantially rectangular windows between each of the dual rectangular strips and extending into the dual rectangular strips, and placing a substantially rectangular transparent material over each window, the transparent material having a greater area than an area of the window. Individual paper products are cut from the roll of paper product; each paper product has dual rectangular strips, one window, and a transparent material covering the window.

In some embodiments of the present invention, a combined thickness of one of the flattened rectangular strips and the transparent material is approximately equal to a thickness of a non-flattened area of the paper product. In some embodiments of the present invention, a portion of the paper product that is covered by the transparent material is not flattened. In some embodiments of the present invention, the paper product is an envelope.

In another embodiment of the present invention is a paper product comprising: a first flattened area having a thickness less than the paper product, a second flattened area having a thickness less than the paper product, and a window cutout located between the first flattened area and the second flattened area. A transparent layer covers the window, the transparent layer having a larger area than the window.

In some embodiments of the present invention, the first flattened area, the second flattened area, and the window are substantially rectangular. In some embodiments of the present invention, a first thick area composed of a first non-flattened portion of the paper product and the transparent layer. In some embodiments of the present invention, a second thick area composed of a second non-flattened portion of the paper product and the transparent layer, the second non-flattened portion being different than the first non-flattened portion. In some embodiments of the present invention, the window cutout extends into the first flattened area and the second flattened area. In some embodiments of the present invention, the paper product is an envelope.

### BRIEF DESCRIPTION OF THE DRAWINGS

FIG. 1 is a roll of envelopes with three envelopes exposed.

FIG. 2 is a close-up view of a window cutout from FIG. 1.

FIG. 3 is representative view of the manufacturing of the envelopes from FIG. 1.

FIG. 4 is a partial cross-sectional side view of a single envelope from FIG. 1.

FIG. 5 is a cross-sectional side view of a roll of envelopes from FIG. 1.

FIG. 6 is flowchart of a method for manufacturing envelopes according to FIG. 1.

### DETAILED DESCRIPTION OF THE INVENTION

The exemplary embodiments of the present invention may be further understood with reference to the following description and the related appended drawings, wherein like elements are provided with the same reference numerals. The exemplary embodiments of the present invention are related to an envelope and a high speed method of manufacturing the envelope. Specifically, the envelope is flattened such that only a small area that is not flattened is covered by the added transparent layer, and the transparent layer does not significantly increase the thickness above the non-flattened portions of the envelope. The exemplary embodiments are described with reference to an envelope, but those skilled in the art will understand that the present invention may be implemented on any high speed manufacturing method where the inclusion of a second layer increases the thickness of the product.

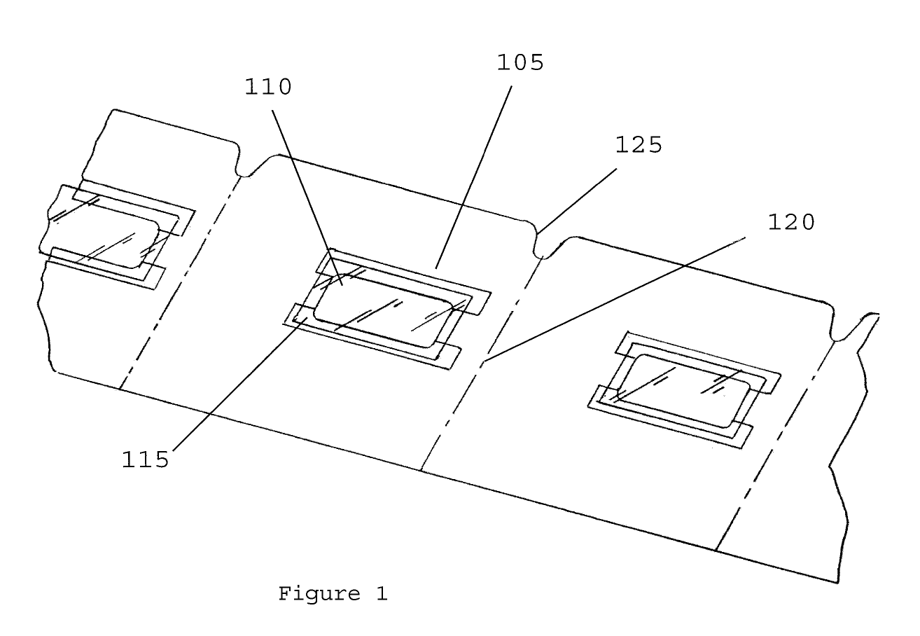

As best seen in FIG. 1, an unwound roll of envelopes with two envelopes exposed is shown. The roll of envelopes can be used in any high speed manufacturing of envelopes. It should be noted that the roll is shown as being envelopes; however, the manufacturing process can be used with any roll and can be any paper product or a non-paper product that can be run through a high-speed manufacturing process. The roll of unfolded envelopes consists of many unfolded envelopes 105 attached together. In a preferred embodiment, the roll consists of over 15,000 unfolded envelopes. Unfolded envelope 105 can be any size envelope. For example, unfolded envelope 105 can be sized as an A1, A2, A6, A7, A8, A9, A10, C4, C5, C6, or any other type of known or new envelope size.

Unfolded envelope 105 is separated from other envelopes by a dividing line 120. Unfolded envelope 105 may have a perforated line 120 to allow the envelopes to be detached by hand, or it may be detached by the manufacturing process. Dividing line 120 may also not be perforated, but still show a dividing line to allow a person viewing the manufacturing process to be able to distinguish each unfolded envelope 105. Finally, dividing line 120 may not be present, and the manufacturing process may include an automatic cutting of the envelope paper to separate out the envelopes. Additionally, envelopes 105 may be imprinted with certain known shapes, such as the envelope flap or envelope window, prior to the manufacturing process.

Unfolded envelope 105 includes a window cutout 110. Window cutout 110 can be of any size and shape, but preferably is substantially rectangular. Window cutout 110 allows the user of the envelope to use an address printed on the contents of the envelope to be seen outside the envelope (through the window) negating the need to print each individual address on the envelope. Unfolded envelope 105 also includes a layer of transparent material 115. Transparent layer 115 has a larger area than the area of window cutout 110. Transparent layer 115 may be of the same width as window cutout 110 with a longer length than window cutout 110. Transparent layer can be of any shape such that it completely covers window cutout 110, however, transparent layer 115 is preferably shaped similar to window cutout 110, shaped substantially rectangular. Finally, unfolded envelope 105 may have a cutout 125 shaped similarly to the curve in the flap of an envelope. If cutout 125 is precut, then each unfolded envelope 105 can be detached and folded into the shape of an envelope without any additional modifications to the envelope. It should be noted, however, that cutout 125 need not be precut, and can be cut at the same time as window cutout 110 or at a later time in the manufacturing process.

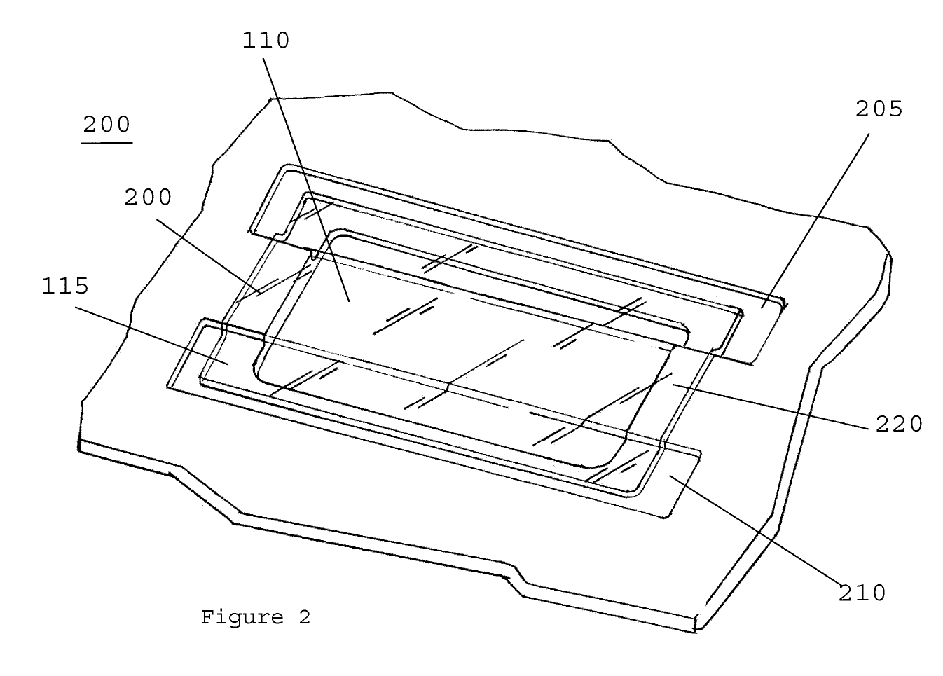

As best seen in FIG. 2, a close-up view 200 of the area surrounding window cutout 110 is shown. Close-up view 200 is a close-up of the area surrounding window cutout 110 with exaggerated features. The features shown may not be easily visible to the naked eye, and are exaggerated for ease of description.

Close-up 200 has two strips 205 and 210. Strips 205 and 210 are preferably rectangular in shape and are longer than the length of window cutout 110. It should be noted, however, that strips 205 and 210 need not be rectangular and can be any shape such that a portion of each strip 205 and 210 extends beyond the length of window cutout 110. Rectangular strips 205 and 210 are placed on unfolded envelope 105 such that window cutout 110 either borders each strip 205 and 210 or extends into each strip 205 and 210.

Strips 205 and 210 are crushed or flattened. Using a roller or any known method of flattening or crushing, each strip is flattened to a thickness less than the thickness of unfolded envelope 105. Preferably strips 205 and 210 are flattened by an amount approximately equal to the thickness of transparent layer 115 such that the combined thickness of each strip 205 and 210, separately combined with the thickness of transparent layer, 115 is approximately equal to the thickness of the paper of unfolded envelope 105. The result is a substantially uniform thickness in most areas of the paper. This makes the paper easier to manufacture and easier to roll.

Strips 205 and 210 have a length longer than window cutout 110. Transparent layer 115 also has a length longer than window cutout 110. This results in thick areas 215 and 220, located beyond the length of window cutout 110, which have not been flattened but are covered by transparent layer 115. The thickness of thick areas 215 and 220 is greater than the thickness of unfolded envelope 105, being composed of a non-flattened area covered by transparent layer 115. An adhesive used to adhere transparent layer 115 over window cutout 110 may add additional thickness; however the thickness is generally of such a small amount as to not provide a significant amount of thickness to the overall thickness. Finally, strips 205 and 210 may extend beyond the length of transparent layer 115, which is greater than the length of window cutout 110, or may be of a length less than transparent layer 115 but greater than window cutout 110.

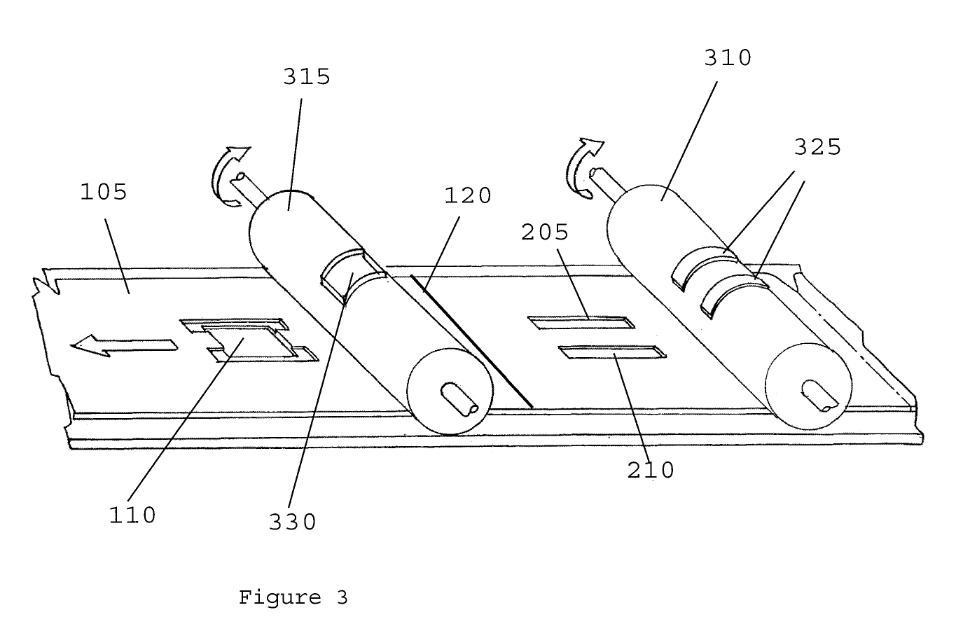

As best seen in FIG. 3, a representative view of the manufacturing process of an envelope according to FIG. 1 is shown. This representative view is purely exemplary, and any other known manufacturing method may be used to flatten and cut unfolded envelope 105.

As stated above, unfolded envelope 105 is attached to similar envelopes to form a continuous roll of paper. Each unfolded envelope 105 may have a dividing line 120 such that each separate envelope can be easily distinguished from adjacent envelopes. The roll of envelopes (Not Shown) is fed into a machine (not shown) and unrolled to allow access to each unfolded envelope 105. The unrolled portion of a roll may be supported by a conveyor belt (not shown) or may be fed directly through rollers. Roller 310 crushes strips 205 and 210 into each unfolded envelope 105 using crushing area 325. Roller 310 is preferably sized large enough such that each full revolution of the roller corresponds to the next location to be flattened in the adjacent envelope. If no conveyor belt is used, a second roller may be used to provide support and the opposing force allowing roller 310 to flatten strips 205 and 210 into envelop 105.

Envelop 105 is then fed into roller 315 which is used to cutout out window cutout 110 through cutout mechanism 330. Roller 315 is preferably sized large enough such that each full revolution of the roller corresponds to the next location of the window cutout in the adjacent envelope. If no conveyor belt is used, a second roller may be used to provide support and the opposing force allowing roller 315 to cutout window cutout 110.

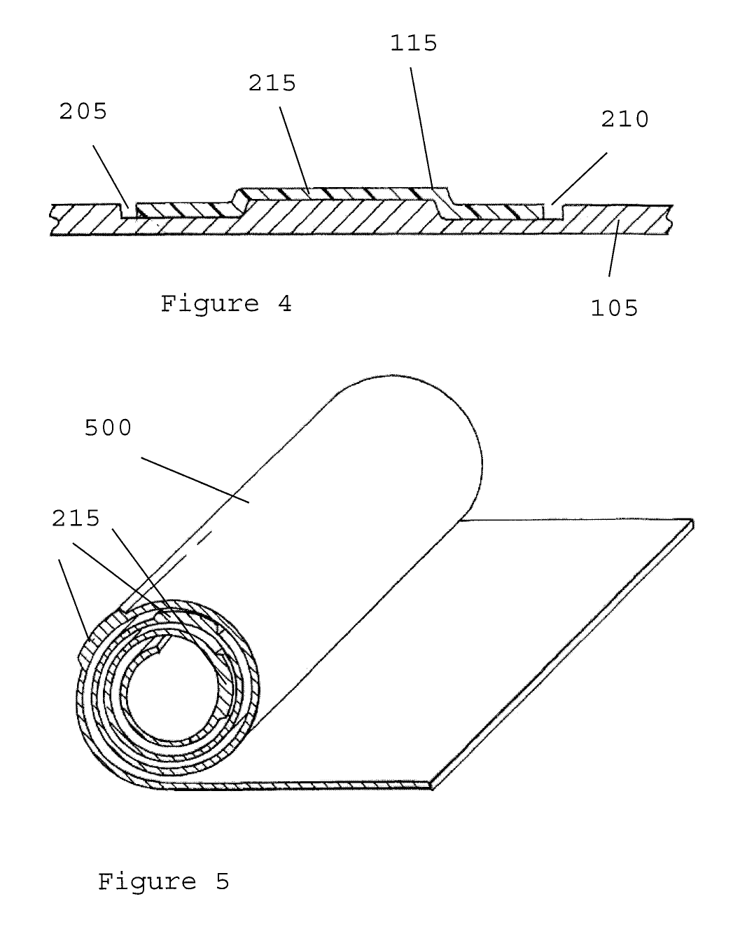

As best seen in FIG. 4, a partial cross-sectional side view of unfolded envelope 105 is shown. The dimensions have been exaggerated to more easily see the crushing and thick areas of unfolded envelope 105. Additionally, FIG. 4 shows only a close up of the area surrounding window 110.

Unfolded envelope 105 has two crushed strips 205 and 210 which are crushed to a thickness less than the thickness of unfolded envelope 105. This creates an indentation in unfolded envelope 105. Between crushed strips 205 and 210 is a thick area 215 that has not been crushed. A transparent layer 115 is placed over crushed strip 205 and 210 as well as thick area 215. The thickness of the transparent layer 115 plus the thickness of each crushed area, individually, is approximately equal to the thickness of unfolded envelope 105. However, as thick area 215 has not been crushed, the thickness of thick area 215, including transparent layer 115, is thicker than the thickness of unfolded envelope 105. As unfolded envelope 105 has two thick areas 215 and 220, there are two areas on unfolded envelope 105 that have a thickness greater than the thickness of unfolded envelope 105.

As best seen in FIG. 5, a cross-sectional side view of a roll of envelopes is shown. Roll 500 is a roll of a plurality of envelopes that have undergone the manufacturing process. Each envelope has two thick areas 215 and 220 (note 220 is not shown in FIG. 5). When the envelopes are rolled together, there is a plurality of thick areas in roll 500. In general, each thick area is offset from the thick area of the adjacent roll. After all of the envelopes in the roll have undergone the manufacturing process, there are many areas of the roll that are thicker than others; for example, thick areas 215. The result is that roll 500 has a plurality of small bulges that may not be seen by the naked eye, and are confined to a small area so as not to interfere with the current manufacturing process or any further manufacturing processes.

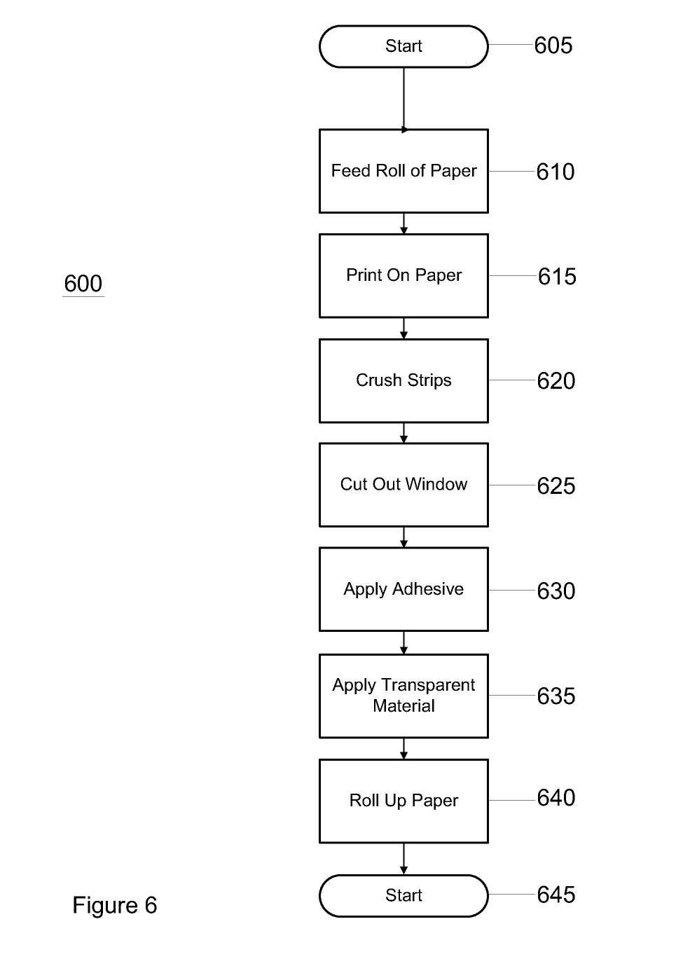

As best seen in FIG. 6, a method 600 of manufacturing unfolded envelope 105 is shown. At step 605 the method begins with a roll of paper. The paper may be precut with the flap of the envelope prior to method 600, or the flap of the envelope may be cut into the paper during method 600. At step 610 the roll of paper is fed into the manufacturing machine. The manufacturing machine can be any know manufacturing machine, and an existing machine can be modified to incorporate method 600.

At step 615 an image of an unfolded envelope is printed on the paper; the printing may include the bottom and side of the envelope and may include the flap of the envelope if the flap is not precut. The printing may also take place prior to feeding the roll of envelopes into the machine, thus not taking place during method 600. At step 620 two strips are crushed in the paper. As stated above, the strips may be rectangular in shape and may be substantially parallel, however, the strips need not be parallel and need not be rectangular in shape. In step 625 the window is cut out of the envelope. As stated above the window is preferably substantially rectangular and is sized to allow an address, printed on a piece of paper meant to be housed in the envelope, to be seen. It should be noted that while the strips are crushed prior to the cutting of the window, method 600 can be modified such that the window is cut prior to the crushing of the strips.

At step 630 an adhesive layer is applied to the envelope in the area surrounding the window cutout. At step 635 a transparent layer of material is applied over the window and over the layer of adhesive material. It should be noted, however, that the transparent material may have the adhesive applied to it prior to being applied to the envelope, and no adhesive is applied directly to the envelope itself. At step 640 the paper product is rolled up to be easily transported and method 600 ends at step 645 where a further roll of paper may be fed into the machine and method 600 may begin over again.

This envelope and method has the advantage of limiting the raised area caused by the inclusion of a transparent material layer over the envelope. Rolls of envelopes are much easier to handle and to transport as the uniformity in the shape and size is maintained. It would be appreciated by those skilled in the art that various changes and modification can be made to the illustrated embodiment without departing from the spirit of the invention. All such modification and changes are intended to be covered hereby.

What is claimed is:

1. A method for manufacturing a paper product having a transparent window comprising the steps of:
flattening two rectangular strips in the paper;
cutting out a substantially rectangular window between the two rectangular strips, the window extending into the two rectangular strips;
placing a substantially rectangular transparent material over the window, the transparent material having a greater length and greater width than the window.

2. The method of claim 1, wherein a combined thickness of one of the flattened rectangular strips and the transparent material is approximately equal to a thickness of a non-flattened area of the paper product.

3. The method of claim 1, wherein a portion of the paper product that is covered by the transparent material is not flattened.

4. The method of claim 1, wherein the paper product is an envelope.

5. The method of claim 1, wherein a roller flattens the two rectangular strips.

6. The method of claim 1, wherein the paper product is a roll of paper and a plurality of rectangular strips are flattened, a plurality of windows are cut, and transparent material is placed over each window.

7. The method of claim 6, further comprising cutting individual paper products from the roll of paper product, each paper product having two rectangular strips, one window, and a transparent material covering the window.

8. A method for manufacturing a paper product having a transparent window comprising the steps of:
flattening two portions of the paper;
cutting out a window between the two portions;
placing a transparent material over the window, the transparent material having a greater area than an area of the window.

9. The method of claim 8, wherein the two flatten portions are substantially rectangular.

10. The method of claim 8, wherein the window is substantially rectangular.

11. The method of claim 8, wherein a portion of the paper product that is covered by the transparent material is not flattened.

12. The method of claim 8, wherein a combined thickness of one of the flattened portions and the transparent material is approximately equal to a thickness of a non-flattened area of the paper product.

13. The method of claim 8, wherein the paper product is an envelope.

14. The method of claim 8, wherein the paper product is a roll of paper and a plurality of flattened portions are flattened on the roll, a plurality of windows are cut, and transparent material is placed over each window.

15. The method of claim 14, further comprising cutting individual paper products from the roll of paper product, each paper product having two flattened portions, one window, and a transparent material covering the window.

16. A method for manufacturing a roll of paper product having a plurality of transparent windows comprising the steps of:
flattening a plurality of dual rectangular strips in the roll;
cutting out a plurality of substantially rectangular windows between each of the dual rectangular strips and extending into the dual rectangular strips;
placing a substantially rectangular transparent material over each window, the transparent material having a greater area than an area of the window;
cutting individual paper products from the roll of paper product, each paper product having dual rectangular strips, one window, and a transparent material covering the window.

17. The method of claim 16, wherein a combined thickness of one of the flattened rectangular strips and the transparent material is approximately equal to a thickness of a non-flattened area of the paper product.

18. The method of claim 16, wherein a portion of the paper product that is covered by the transparent material is not flattened.

19. The method of claim 16, wherein the paper product is an envelope.

20. A paper product comprising:
a first flattened area having a thickness less than the paper product;
a second flattened area having a thickness less than the paper product;
a window cutout located between said first flattened area and said second flattened area;
a transparent layer covering said window, said transparent layer having a larger area than said window.

21. The paper product of claim 20, wherein said first flattened area, said second flattened area, and said window are substantially rectangular.

22. The paper product of claim 20, further comprising a first thick area composed of a first non-flattened portion of the paper product and the transparent layer.

23. The paper product of claim 20, further comprising a second thick area composed of a second non-flattened portion of the paper product and the transparent layer, said second non-flattened portion being different than said first non-flattened portion.

24. The paper product of claim 20, wherein said window cutout extends into said first flattened area and said second flattened area.

25. The paper product of claim 20, wherein said paper product is an envelope.
